(19) United States
(12) Patent Application Publication
(10) Pub. No.: US 2012/0311127 A1
(43) Pub. Date: Dec. 6, 2012

(54) Flyway Generation in Data Centers

(75) Inventors: Srikanth Kandula, Redmond, WA (US); Daniel Halperin, Seattle, WA (US); Jitendra Padhye, Redmond, WA (US); Paramvir Bahl, Bellevue, WA (US)

(73) Assignee: MICROSOFT CORPORATION, Redmond, WA (US)

(21) Appl. No.: 13/118,749

(22) Filed: May 31, 2011

(51) Int. Cl. G06F 15/16

(52) U.S. Cl. 709/224; 709/243; 709/223

(57) ABSTRACT

The subject disclosure is directed towards configuring and controlling wireless flyways (e.g., communication links between server racks provisioned on demand in a data center) to operate efficiently and without interfering with one another. Control and flyway selection may be based upon steered antenna directionality, channel, location in the data center, transmit power, and measured and/or predicted (estimated) network traffic. Flyways also may be used to route indirect traffic to reduce traffic on a bottleneck (e.g., wired) link. A payload may be sent over a over a wireless flyway with acknowledgment via a wired backchannel so that wireless communication is in one direction. The lack of interference and communication in one direction facilitates flyway operation without a backoff function and/or without clear channel assessment.

### BACKGROUND

Large network data centers provide economies of scale, large resource pools, simplified IT management and the ability to run large data mining jobs. Containing the network cost is an important consideration when building large data centers. Networking costs are one of the major expenses; as is known, the cost associated with providing line speed communications bandwidth between an arbitrary pair of servers in a server cluster generally grows super-linearly to the size of the server cluster.

Production data center networks use high-bandwidth links and high-end network switches to provide the needed capacity, but they are still over-subscribed (lacking capacity at times) and thus suffer from sporadic performance problems. Oversubscription is generally the result of a combination of technology limitations, the topology of these networks (e.g., tree-like) that requires expensive “big-iron” switches, and pressure on network managers to keep costs low. Other network topologies have similar issues.

U.S. patent application Ser. No. 12/723,697, hereby incorporated by reference, describes dynamically provisioning communications links, referred to as flyways, in an oversubscribed base network wherever additional network communications capacity is needed. Flyways save considerable hardware cost, and thus any improvement to flyway technology is thus desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which wireless flyways are configured, selected and/or controlled so as to operate efficiently. This may include having one server using a flyway mechanism to communicate wirelessly with another server, with the other server acknowledging via a wired connection to allow the wireless flyway communication path to transmit data in only one direction. In a similar manner, flyway mechanisms can be used to enable any two network elements such as switches or routers to communicate wirelessly with one another. Control may be based upon one or more factors including antenna directionality, channel, location in the data center, transmit power, and measured and/or predicted (estimated) network traffic between the two entities. Flyways also may be used to route indirect traffic to reduce traffic on a bottleneck (e.g., wired) link.

In one aspect, the flyway mechanisms are configured and controlled to communicate in only one direction and/or without any interference. For example, the flyway mechanisms may be 60 GHz devices positioned in a data center and electronically steered and/or transmit power controlled to allow communication with one another without interfering with communication on a same channel being used simultaneously by another flyway mechanism in the data center. A flyway mechanism may thus operate without a backoff function, and/or without clear channel assessment.

In one aspect, a payload is sent from a first server over a wireless flyway to a second server; the first server receives the acknowledgment from the second server via a wired backchannel. For a time the wireless flyway only transmits in a direction from the first server to the second server. A token may be used by the servers to switch to an opposite direction and transmit over the wireless flyway from the second server to the first server.

In one aspect, measured and/or predicted network traffic is determined between network devices, and used to pick proposed flyways. A validator validates each proposed flyway based upon a channel model to determine whether each proposed flyway is capable of operating without interference with another flyway. If so, the flyway is provisioned. To validate a flyway, a channel model, controllable directionality, transmit power and flyway location may be used as factors to determine that a proposed flyway will not interfere with another flyway. Indirect traffic may be routed through at least one provisioned flyway, and a flyway may be chosen for handling indirect traffic based upon an amount of traffic that the flyway will be able to divert away from a bottleneck link.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example data center incorporating flyway mechanisms by which flyways may be established.

FIG. 2 is an example representation of flyways set up between network machines.

FIG. 3 is an example representation of wireless flyway communication between endpoints, based on antenna directionality that allows simultaneous non-interfering communications even on the same communications channel.

FIG. 4 is a block diagram showing a flyway controller that selects and validates flyways based on known information and measured or predicted traffic demands.

FIGS. 5A-5D are representations of selecting flyways based upon network transit traffic and capacity considerations.

FIG. 6 is a block diagram representing an exemplary computing environment into which aspects of the subject matter described herein may be incorporated.

### DETAILED DESCRIPTION

Various aspects of the technology described herein are generally directed towards improvements to flyway technology. In one aspect, the use of wired backchannels for scheduling wireless communications improves efficiency, including by determining which flyway mechanisms communicate with one another, on which channel and at what time. Further, controlling antenna directionality and/or transmission power in accordance with the schedule and/or other network considerations allows the same channel to be used at the same time in the network, without collisions. Still further, changes to 802.11 ad MAC and PHY protocols improve communication efficiency by sending ACK packets to wireless payload transmissions over the wire instead of over the wireless connection, which reduces protocol overhead. Also described are flyway generation algorithms, including using flyways for indirect transit traffic, which further improve network communications.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and computer networks in general.

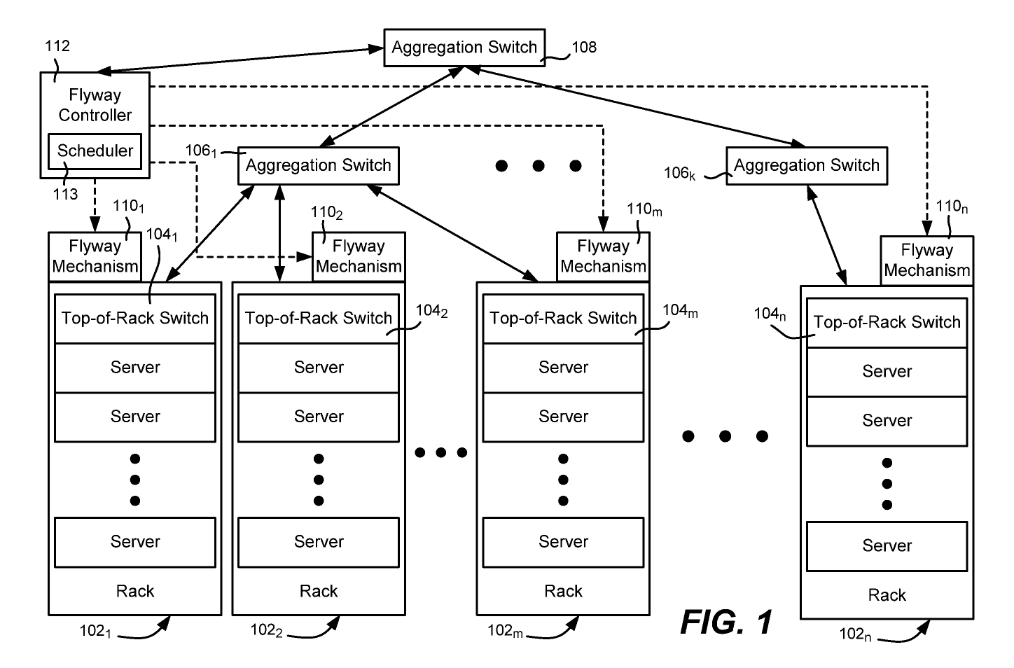

FIG. 1 shows a production network based upon a tree-like topology. A plurality of racks 102₁-102ₙ each have servers, which communicate through a top of rack switch 104₁-104ₙ. A typical network has twenty to forty servers per rack, with increasingly powerful links and switches going up the tree. Note that flyways are not limited to tree-like topologies, but can be used in any topology, including clos networks and other forms of mesh topologies, and FatTree topologies.

As represented in FIG. 1, each top of rack switch 104₁-104ₙ is coupled to one another through one or more aggregation switches 106₁-106ₖ. In this way, each server may communicate with any other server, including a server in a different rack. Note that in this example, a higher-level aggregation switch 108 couples the rack-level aggregation switches 106₁-106ₖ, and there may be one or more additional levels of aggregation switch couplings.

Application demands generally can be met by an oversubscribed network, but occasionally the network does not have sufficient capacity to handle “hotspots.” Flyways, implemented as flyway mechanisms 110₁-110ₙ, provide the additional capacity to handle extra data traffic as needed.

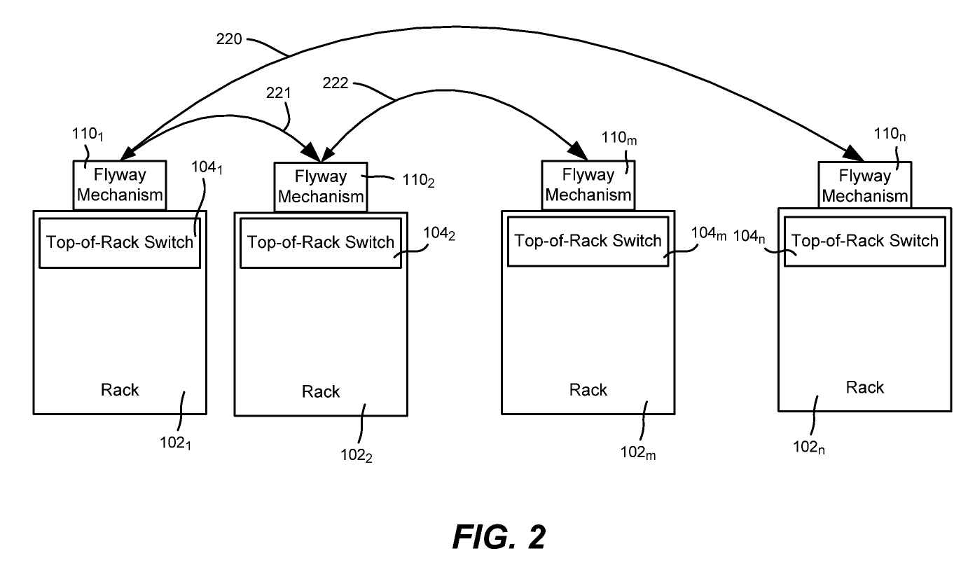

As represented in FIGS. 1 and 2, flyways (the curved arrows in FIG. 2) are controlled by a flyway controller 112. The flyways may be dynamically set up by the flyway controller 112 on an as-needed basis, and taken down when not needed (or needed elsewhere). As described herein, the controller includes a scheduler 113 and other components that provide information to the flyway mechanisms 110₁-110ₙ to control their communications with one another.

FIG. 2 shows how one flyway 220 may be used to link racks 102₁ and 102ₙ and their respective top-of-rack switches 104₁ and 104ₙ, while another flyway 222 links racks 102₂ and 102ₘ and their respective top-of-rack switches 104₂ and 104ₙ. Note that a rack/top-of-rack switch may have more than one flyway at any time, as represented by the flyway 221 between racks 102₁ and 102₂. While a single flyway mechanism is shown per rack, it can be appreciated that there may be more than one flyway mechanism per rack (or multiple devices in a single flyway mechanism), possibly using different communications technologies (e.g., wireless and optical).

Analysis of traces from data center networks shows that, at any time, only a few top-of-rack switches are “hot,” that is, they are sending and/or receiving a large volume of traffic. Moreover, when hot, top-of-rack switches typically exchange much of their data with only a few other top-of-rack switches. This translates into skewed bottlenecks, in which just a few of the top-of-rack switches lag behind the rest and hold back the entire network. The flyways described herein provide extra capacity to these few top-of-rack switches and thus significantly improve overall performance. Indeed, only a few flyways, with relatively low bandwidth, significantly improve the performance of an oversubscribed data center network.

The performance of a flyway-enhanced oversubscribed network may approach or even equal to that of a non-oversubscribed network. One way to achieve the most benefit is to place flyways at appropriate locations. Note that network traffic demands are generally predictable/determinable at short time scales, allowing the provisioning of flyways to keep up with changing demand. As described herein, in one implementation, the central flyway controller 112 gathers demand data, adapts the flyways in a dynamic manner, and switches paths to route traffic.

Another way of using flyways is to choose a traffic-oblivious set of flyway links. Such a choice of flyway links generally changes infrequently, and is based on long-term estimates of demand and/or link quality. To route demands on such a network comprising a wired backbone and flyways links, straightforward traffic engineering schemes that steer traffic away from hotspots to places where additional capacity is available may be used. For certain traffic demands, a substantial fraction of the improvement due to flyways may be obtained by using a set of flyway links that changes only infrequently.

Flyways may be added to a network at a relatively small additional cost. This may be accomplished by the use of wireless links (e.g., 60 GHz, optical links and/or 802.11n) and/or the use of commodity switches to add capacity in a randomized manner. In general, any flyway mechanism can link to any other flyway mechanism, as long as they meet coupling requirements (e.g., within range for wireless, has line-of-sight for optical and so on).

Thus, the flyways may be implemented in various ways, including via wireless links that are set up on demand between the flyway mechanisms (e.g., suitable wireless devices), and/or commodity switches that interconnect subsets of the top-of-rack switches. As described hereinafter, 60 GHz wireless technology is one implementation for creating the flyways, as it supports short range (1-10 meters), high-bandwidth (1 Gbps) wireless links. Further, the high capacity and limited interference range of 60 GHz provides benefits.

Still further, 60 GHz wireless technology allows for directional antennas with relatively narrow radiation patterns (antenna cones) that enable relatively compact 60 GHz devices to run at multi-Gbps rates over distances of several meters, with the cones electronically steered and/or power controlled, thus allowing flyway mechanisms to be densely packed in a data center. More particularly, directionality allows network designers to increase the overall spectrum efficiency through spatial reuse. Further, the transmission power of devices may be controlled, again facilitating spatial reuse. Thus, for example, two sets of communications between four top-of-rack switches can occur simultaneously on the same channel because of directionality and/or range control.

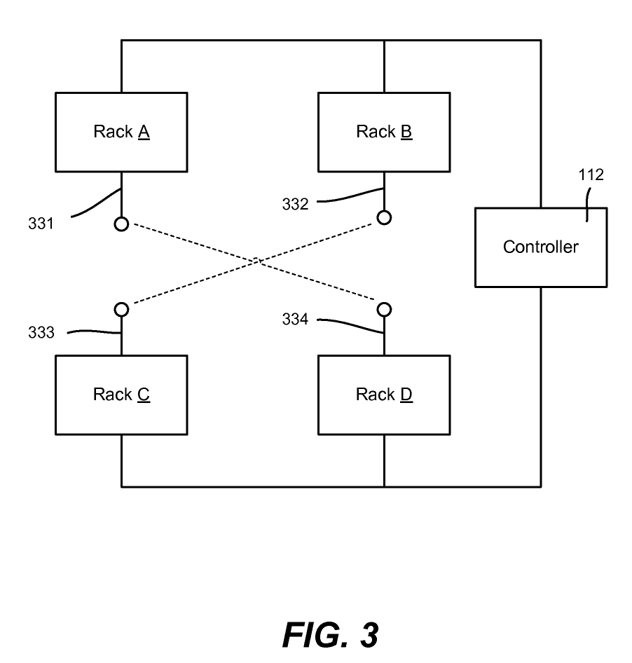

FIG. 3 shows example racks A-D, each with a wireless flyway mechanism as represented by the antennas 331-334, respectively. As a result of the directionality, as well as the physical layout being known to the controller 112, racks A and D can be controlled to communicate with one another, while racks C and B can be controlled to communicate with one another, at the same time on the same channel.

In addition to using directional antennas at both the sender and the receiver to mitigate interference between flyways and thereby provide good performance, interference may be mitigated by using multiple channels, and/or by controlling which flyways are activated at what times.

Wireless flyways are controlled to form links on demand, and thus may be used to distribute the available capacity to whichever top-of-rack switch pairs need it as determined by the central flyway controller 112. A general goal is to configure the flyway links and the routing to improve the time to satisfy traffic demands, which may be measured by the completion time of the demands, that is, the time it takes for the last flow to complete.

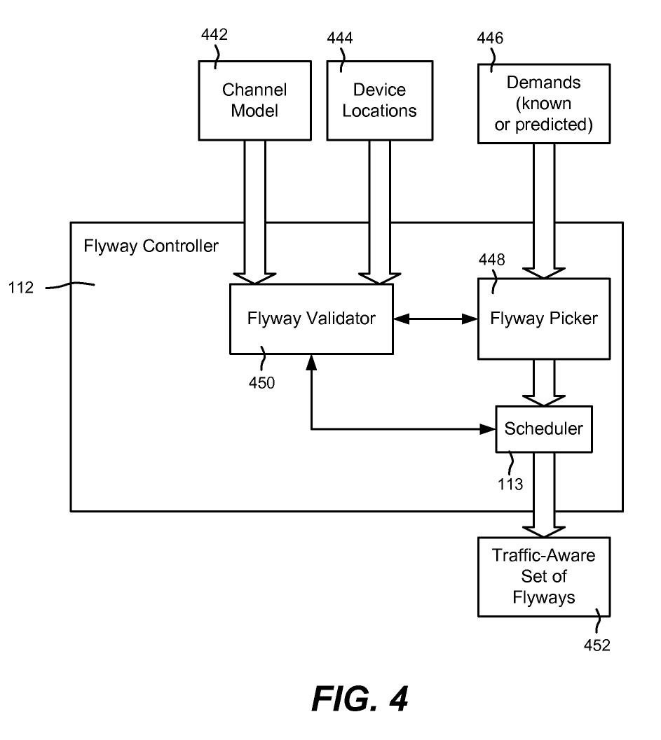

As represented in FIG. 4, inputs to the controller 112 may include antenna characteristics, a measured 60 GHz channel model 442, device locations 444 and traffic demands 446, if available as described below. For clusters that are orchestrated by cluster-wide schedulers (e.g., map-reduce schedulers), logically co-locating one system with such a scheduler makes traffic demands visible. In this mode, the controller 112 picks flyways appropriate for these demands. In clusters that have predictable traffic patterns, instrumentation may be used to estimate current traffic demands, so as to select flyways that are appropriate for demands predicted based on these estimates.

As represented in FIG. 4, a flyway picker 448 (e.g., incorporated into the flyway controller 112) proposes flyways that if implemented, will improve the completion time of demands (described below). A measurement and channel-model-driven flyway validator 450 confirms or rejects each proposal. The validator 450 ensures that the system only adds non-interfering flyways. In addition, the validator 450 also predicts how much capacity the flyways will have. This allows the flyway picker 448 to add flyways to an approved traffic-aware flyway set 452 and propose flyways for subsequent hotspots. The process repeats until no more flyways can be added to the set 452, whereby the scheduler 113 is able to control each flyway as described herein. Other ways to select and adds flyways are feasible, however, the above-described model finishes quickly, scales well and provides significant gains in practice.

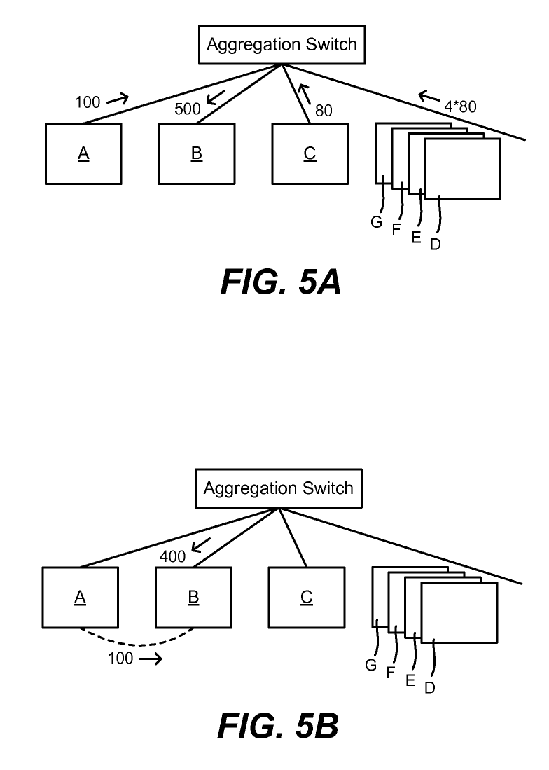

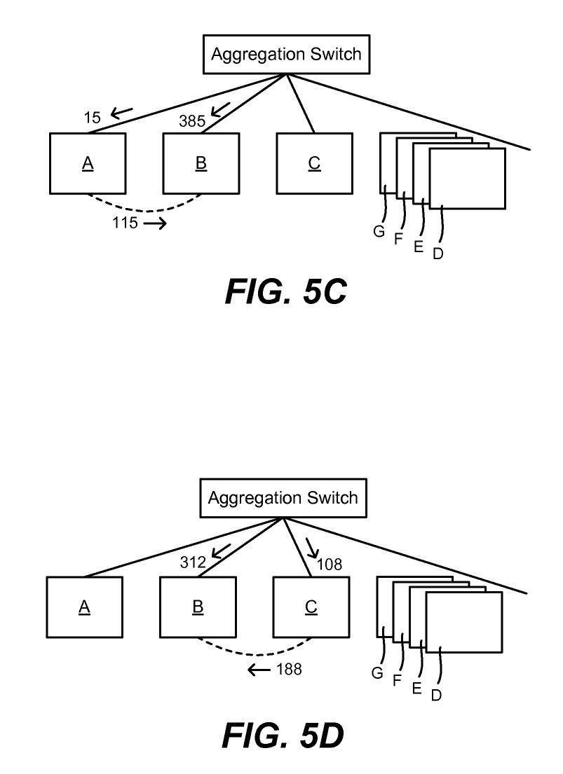

By way of example, consider the network in FIG. 5A. Six top-of-rack switches A and C-G have traffic to send to top-of-rack switch B. A has 100 units to send, whereas the rest each send 80 units. Each top-of-rack switch has one wireless device connected to it. In this example, the wired link capacity in and out of the top-of-rack switches is 10 units/second; for simplicity the example assumes that these are the only potential bottlenecks. The downlink into B is the bottleneck in the example of FIG. 5A, carrying 500 units of traffic in total and thus taking 50 seconds to do so; the completion time is thus 50 seconds.

FIG. 5B represents adding a flyway (represented by the curved dashed line) from top-of-rack switch A to top-of-rack switch B to improve the performance of the top-of-rack switch pair that sends the most amount of traffic on the bottleneck link and completes last, referred to as the lagging top-of-rack switch, to help bypass the bottleneck. As FIG. 5B shows, traffic on the bottleneck drops to 400 units, and time to the complete drops to 40 seconds. However, the lagging top-of-rack switch often contributes only a small proportion of the total demand on that link (in this example 100/500), whereby the flyway provides only a corresponding percentage gain, (reducing the completion time to 40 seconds).

Note that there is spare capacity on the flyway; the demand from A to B completes after approximately 33.3 seconds, approximately 6.7 seconds before the traffic from C-G. Note that this is common, as in practice very few of the top-of-rack switch pairs on hot links require substantial capacity.

In one aspect, indirect transit traffic is allowed to use the flyway, i.e., as represented in FIG. 5C. In this manner, traffic from other sources to B bypasses the bottleneck by flowing via node A and the flyway. This improves the completion time to 115/3=385/10=38.5 seconds.

Often the lagging top-of-rack switch pair is infeasible or an inferior choice, e.g., the devices at either end may be used up in earlier flyways, the link may interfere with an existing flyway, or the top-of-rack switch pairs may be too far apart. Allowing transit traffic ensures that any flyway that can offload traffic on the bottleneck will be of use, even if it is not between the pair that sends the most amount of traffic on the bottleneck link.

In this example situation, it is more effective to enable the flyway from C to B, with twice the capacity of the flyway from A, as generally represented in FIG. 5D. This decision allows more traffic to be offloaded, and results in a completion time of 312/10=188/6=31.2 seconds.

By allowing transit traffic on a flyway via indirection, the problem of high fan-in (or fan-out) that is correlated with congestion is avoided. Further, doing so opens up the space in potentially useful flyways, whereby making a greedy choice among this set adds substantial value. More particularly, at each step, the flyway chosen may be the one that diverts the most traffic away from the bottleneck link.

For a congested downlink to a top-of-rack (ToR) switch p, the selected “best” flyway is from the top-of-rack switch that has a high capacity flyway and sufficient available bandwidth on its downlink to allow transit traffic through, namely:

$${arg max min}_{To {R}_{i}} ( {C}_{i \to p} , {D}_{i \to p} + {down}_{i} ) .$$

The first term C_{i→p} denotes the capacity of the flyway. The amount of transit traffic is capped by downᵢ, which is the available bandwidth on the downlink to i; and D_{i→p} represents is demand to p. Together, the second term indicates the maximum possible traffic that i can send to p. The corresponding expression of the computed best flyway for a congested uplink to ToR is similar:

$${arg max min}_{To {R}_{i}} ( {C}_{i \to p} , {D}_{i \to p} + {up}_{i} ) .$$

Described is a mechanism that routes traffic across the potentially multiple paths that are available via flyways. In general, flyways are treated as point-to-point links. Note that every path on the flyway transits through exactly one flyway link, so the routing encapsulates packets to the appropriate interface address.

By way of example, to send traffic via A→Core→C→B, the servers underneath A encapsulate packets with the address of C's flyway interface to B. The flyway picker 448 computes the fraction of traffic to flow on each path and relays these decisions to the servers. In one implementation, this functionality may be built into an NDIS filter driver that fits (e.g., as a shim) into the Windows® network stack. These operations can be performed at line speed with negligible addition to server load.

When changing the flyway setup, encapsulation is disabled, and the added routes removed. The default routes on the top-of rack and aggregate switches are not changed, and continue to direct traffic on the wired network. Thus, when the flyway route is removed, the traffic flows over wired the links. During flyway changes (and flyway failures, if any), packets are thus sent over wired network.

As represented in FIG. 4, the flyway picker 448 is aware of traffic demands 446. When co-located with cluster-wide orchestrators, these demands are already available. Further, it is known that applications hint at their traffic demands in some scenarios. To use this information for cases of predictable demands, in one implementation there is provided a traffic estimation module, using end-host instrumentation.

In general, shims at the servers are able to collect traffic statistics, and such functionality is built into the shim described herein. One suitable predictor is a moving average of estimates from the recent past.

The flyway validator 450 determines whether a specified set of flyways can operate together, including by computing the effects of interference and what capacity each link is likely to provide. The flyway validator 450 operates using a known principles for conflict graphs, namely that if the system knows how much signal is delivered between all pairs of nodes in all transmit and receive antenna orientations, these measurements may be combined with the knowledge of which links are active, and how the antennas are oriented, to compute the Signal to Interference-plus-Noise Ratio (SINR) for all nodes.

A SINR-based auto-rate algorithm may select rates, e.g., by computing interference assuming all nodes from all other flyways send concurrently, and add an additional 3 dB. Note that the SINR model and rate selection are appropriate for the data center environment because of the high directionality.

With respect to obtaining the conflict graph, if there are N racks and K antenna orientations, the input to the validator 450 may be an (NK)²-size table of received signal strengths. To generate the (large) table, the data is measured, which need only be done when the data center is configured, as the measurements remain valid over time. Note that entries in the table may be refreshed opportunistically, without disrupting ongoing wireless traffic, by having idle nodes measure signal strength from active senders at various receive antenna orientations and sharing these measurements, along with transmitter antenna orientation, over the wired network.

The table may also be used to determine the best antenna orientation for two top-of-rack switches to communicate with each other, with the complex antenna orientation mechanisms prescribed in 802.11ad no longer needed.

Antennas that use purely directional radiation patterns and point directly at their intended receivers may be used herein. Advanced, more powerful antenna methods such as null-steering to avoid interference may further increase flyway concurrency

To further improve performance, clear channel assessment (CCA) may be disabled. The 802.11ad MAC, like other 802.11 standards, includes a clear channel assessment (CCA) mechanism in which a sender defers its transmission if it senses that ambient noise is above a threshold, so as to avoid collisions with other transmissions that may be in progress. The flyway validator 450 deliberately enables only those flyways that will not adversely affect each other's performance when operating simultaneously. By definition, there are no hidden terminals, and data centers do not suffer from external interference. Thus, a sender need not perform CCA before transmitting, nor care whether other packets are in flight, and/or who is sending them, but rather simply sends packets whenever ready.

In general, data center performance improves as the flyways deliver larger and larger throughputs, up to the largest possible. To this end, further wireless optimizations that leverage the wired backbone in the data center may be used. Independently, each optimization increases throughput to an extent as described below; together they increase flyway TCP throughput on the order of twenty-five percent in one implementation, by taking advantage of the hybrid wired and wireless setting of the data center environment.

In one optimization, protocol overhead is reduced by combination of wired and wireless networking, e.g., with the payload sent by the sending end host over the wireless flyway, and acknowledgement returned by the receiving end host over the wired link. In this way, certain selected packets such as MAC-inefficient packets are offloaded to the wire. For example, TCP ACKs are far smaller than data packets, and make inefficient use of wireless links because acknowledgement payload transmission is relatively minor compared to the packet overheads such as preamble and SIFS. The hybrid wired wireless design of the network facilitates improved efficiency by sending ACK packets over the wire instead. For fast links enabled by the narrow-beam antenna, the performance improves by a substantial amount, e.g., around seventeen percent. Note that the TCP ACK traffic will use some wired bandwidth, but this is relatively trivial compared to the increase in throughput.

For the common case of one-way TCP flows in the data center, if acknowledgements (e.g., TCP ACKs) are sent over the wire as described above, then the traffic over a given wireless link only flows in one direction. Further, because one implementation is based on independent flyways that do not interfere with one another as described above, there are no collisions in the wireless network. As a result, the distributed coordination function backoff mechanism used in wireless protocols may be eliminated. This change improves the TCP throughput by a substantial amount, e.g., around five percent.

Note that occasionally, there may be bidirectional data flows over the flyway. Even in this case, the cost of the distributed coordination function may be removed. To this end, because only the two communicating endpoints can interfere with each other, transmissions may be scheduled on the link by passing a token between the endpoints. Note that this fits into the 802.11 link layer protocol because after transmitting a packet batch, the sender waits for a link layer Block-ACK; this scheduled hand-off is leveraged to let the receiver take the token and send its own batch of traffic.

### Exemplary Operating Environment

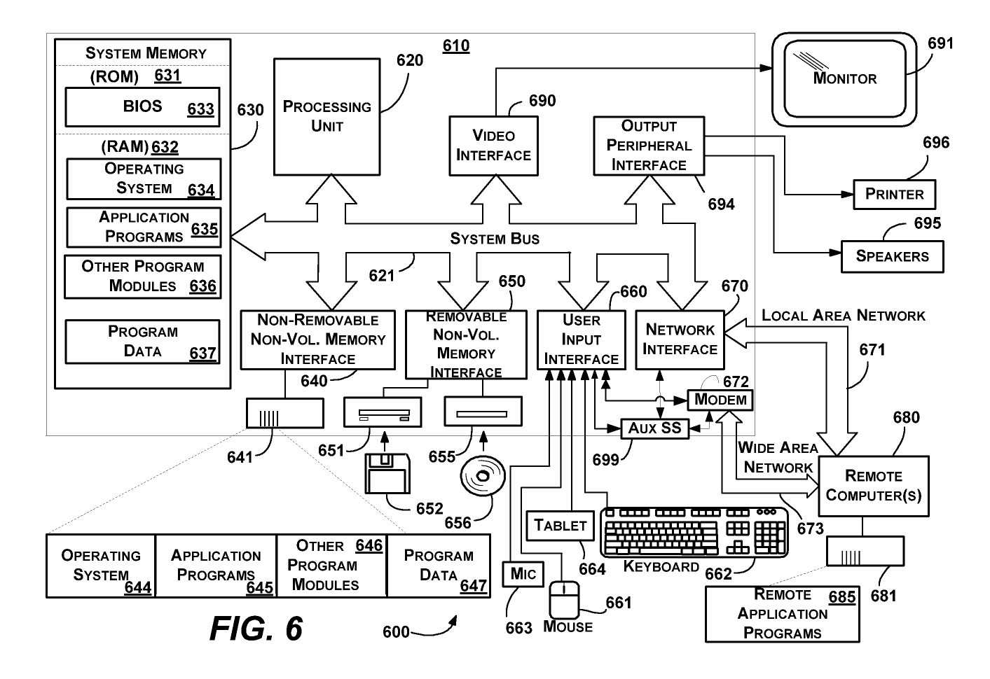

FIG. 6 illustrates an example of a suitable computing and networking environment 600 on which the examples of FIGS. 1-5D may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computer networking environment, a system comprising, a first set of one or more computing devices coupled to a second set of one or more computing devices, the one or more computing devices of the first set configured to communicate with the one or more computing devices of the second set via a wired connection, the first set including a flyway mechanism configured to connect wirelessly to a flyway mechanism of the second set to provide a wireless flyway communication path from the one or more computing devices of the first set to the one or more computing devices of the second set, a computing device of the first set using the flyway mechanism to communicate wirelessly with a computing device of the second set, including to send direct traffic, indirect traffic or both direct traffic and indirect traffic.

2. The system of claim 1 wherein the flyway mechanism of the first set is configured to operate without a backoff function.

3. The system of claim 1 wherein the flyway mechanism of the first set is configured to operate without clear channel assessment.

4. The system of claim 1 wherein the flyway mechanisms comprise 60 GHz devices.

5. The system of claim 4 wherein the flyway mechanisms are positioned in a data center and electronically steered to allow communication with one another without interfering with communication on a same channel being used simultaneously by another flyway mechanism in the data center.

6. The system of claim 4 wherein the flyway mechanisms are positioned in a data center, electronically steered and transmit power controlled to allow communication with one another without interfering with communication on a same channel being used simultaneously by another flyway mechanism in the data center.

7. The system of claim 1 further comprising a controller that selects and controls the first flyway mechanism and the second flyway mechanism based upon measured traffic.

8. The system of claim 1 further comprising a controller that selects and controls the first flyway mechanism and the second flyway mechanism based upon predicted traffic.

9. The system of claim 1 further comprising a controller that selects and controls the first flyway mechanism and the second flyway mechanism based upon a channel model.

10. The system of claim 1 further comprising a controller that selects and controls the first flyway mechanism and the second flyway mechanism based upon physical locations of the flyway mechanisms.

11. The system of claim 1 wherein the computing device of the second set is further configured to send acknowledgements via the wired connection to allow the wireless flyway communication path to transmit data in only one direction.

12. The system of claim 1 further comprising a controller that selects and controls the first flyway mechanism and the second flyway mechanism based upon estimates of demand or link quality, or both demand and link quality

13. One or more computer-readable media having computer-executable instructions, which when executed perform steps, comprising, sending a payload from a first server over a wireless flyway to a second server, and receiving an acknowledgment from the second server at the first server via a wired backchannel.

14. The one or more computer-readable media of claim 13 wherein for a time the wireless flyway only transmits in a direction from the first server to the second server, and having further computer-executable instructions comprising, communicating a token to switch to an opposite direction to transmit over the wireless flyway from the second server to the first server.

15. In a computing environment, a method performed at least in part on at least one processor, comprising, determining measured or predicted network traffic, or both, between network devices, picking proposed flyways based upon the measured or predicted network traffic, or both, and validating each proposed flyway based upon a channel model to determine whether each proposed flyway is capable of operating without interference with another flyway, and if so, provisioning the flyway.

16. The method of claim 15 further comprising, routing indirect traffic through at least one provisioned flyway.

17. The method of claim 16 further comprising, choosing a provisioned flyway for handling indirect traffic based upon an amount of traffic that the flyway is to divert away from a bottleneck link.

18. The method of claim 15 wherein validating each proposed flyway comprises determining based upon the channel model and controllable directionality that if provisioned, the proposed flyway will not interfere with another flyway.

19. The method of claim 18 wherein validating each proposed flyway comprises determining based upon the channel model and transmit power data that if provisioned, the proposed flyway will not interfere with another flyway.

20. The method of claim 18 wherein validating each proposed flyway comprises determining based upon flyway location data that if provisioned, the proposed flyway will not interfere with another flyway.
